(19) United States
(12) Patent Application Publication
(10) Pub. No.: US 2011/0267195 A1
(43) Pub. Date: Nov. 3, 2011

(54) System For Displaying And Quantifying Hits In Real Time Using Monitors Or Large-Format Projection Screens

(76) Inventor: Manfred Helzel, Wurzburg (DE)

(21) Appl. No.: 13/126,804

(22) PCT Filed: Nov. 6, 2008
(86) PCT No.: PCT/EP2008/065059

§ 371 Date: Jul. 6, 2011

(51) Int. Cl. G08B 23/00; G01N 3/00

(52) U.S. Cl. 340/573.1; 73/12.04

(57) ABSTRACT

For displaying impact, impulse, acceleration, and/or pressure effects on a part of the body of a living thing, having a covering element for covering the part of the body that is to be monitored, said element having sensors for detecting the impact, impulse, acceleration and/or pressure effects, and a transmission device for transmitting the impact, impulse, acceleration and/or pressure values detected by the sensors, a receiving device for receiving the transmitted impact, impulse, acceleration and/or pressure values, and a display device for the transmitted impact, impulse, acceleration, and/or pressure values, wherein a plurality of sensors are arranged within the covering element, at a spatial distance from each other, for detecting the location and the intensity of the impact, impulse, acceleration and/or pressure effects, and information about the location of the impact, impulse, acceleration, and/or pressure effects and/or for identifying the detecting sensor is transmitted, together with the detected impact, impulse, acceleration, and/or pressure effects, by the transmission device.

The invention relates to a system for displaying the effects of impacts, impulses, acceleration, and/or pressure on a part of the body of a living thing, according to the preamble of claim 1, and to a covering element comprising integrated sensors for a part of the body and a display device for displaying the impact, impulse, acceleration, and/or pressure effects, according to claims 11 and 12, respectively.

In a multitude of sports, various factors, for example, impact, pressure, impulse, or acceleration forces, affect the body or parts of the body of the athlete. More particularly, in contact sports the problem exists that the factors affecting the athlete can result in injuries, which in some cases can be life-threatening. Therefore, it is necessary to be able to monitor the effects on the athlete, and in the case of intense effects, to be able to intervene rapidly enough to prevent severe injuries. More particularly, in the sport of boxing, preventing brain injuries is an important goal.

At the same time, specifically at sporting events, it is of great interest particularly to spectators for the effects experienced by an athlete to be visually displayed for the spectators.

US 2006/001 52 87 A1 describes a system for displaying various data, such as acceleration or stress experienced by an athlete while playing his sport. However, the system according to US 2006/001 52 87 A1 is concerned essentially with determining the location and the speed of the athlete.

DE 102 10 975 B4 describes a helmet comprising a sensor for detecting an effect on the helmet, wherein, following a triggering event, an emergency signal is sent via mobile telephone to an emergency call center. However, in this case it is not possible to determine the precise location affected by the pressure, because the pressure sensor according to DE 102 10 975 B4 consists solely of strip gauges, which indicate an intense effect in the case of irreversible plastic deformations of a hard shell helmet. Moreover, it is not possible using the sensor according to DE 102 10 975 B4 to measure the precise intensity of the effect, as only irreversible plastic deformations are detected, or in practical terms, a threshold value, which, when reached, triggers a display by the sensor.

It is therefore necessary to provide a system with which both the location and the intensity of the effect on a part of the body can be displayed. This problem is solved with a system according to claim 1 and with a covering element according to claim 11 and a display device according to claim 12. Advantageous further developments are specified in the dependent claims.

A system according to the invention comprises at least one covering element, which is used for covering the part or parts of the body that is or are to be monitored and displayed by the system. A plurality of sensors for detecting impact, impulse, pressure and/or acceleration effects are integrated into said covering element. The sensors are spaced at a defined distance from one another, and have access to information such as an identification number, which allows the supplied values to be assigned to a specific sensor, and thereby to a specific region of the covering element. Such assignment is possible using information transmitted by the sensor along with the measured value, for example, an identification number or the position in the covering element, which is stored in the sensor. In another embodiment of the invention, however, it is also possible to provide a central controller in the covering element, which has access to stored information about the individual sensors for detecting the impact, impulse, pressure, and/or acceleration effects, and assigns the measured values to the individual sensors via a plurality of inputs.

Moreover, the covering element according to the invention is equipped with a transmission device, with which the measured values and the information for identifying the individual sensors, and therefore for assigning the individual values to specific sensors or to a specific region of the covering element, are transmitted to a display device.

Said display device is equipped with a corresponding receiving device, which is embodied for receiving the data from the impact, impulse, pressure and/or acceleration sensors, which is transmitted by the transmission device. Using the together with the [sic—Translator] measurement data, i.e., impulse, impact, pressure and/or acceleration values, transmitted by the sensors, and the associated identification data, the display device can assign the measured values to specific regions of the covering element and thus to the corresponding regions of the part of the body to be monitored that lie beneath said element. Said assignment either can be carried out in the controller in the covering element or can be carried out using location assignment values, stored in the display device, for the individual pressure sensors.

In one advantageous embodiment of the invention, a graphic display of the part of the body to be monitored is also displayed on the display device. In this case, simplified, rough-sketch illustrations are conceivable; however, a part of the body can also be illustrated using 3-D technologies, as are known in the computer industry. The impact, impulse, acceleration and/or pressure effect on the part of the body is then displayed on this graphic display. In this case, it is possible, for example, to display the value of the pressure effect at the location in the graphic display of the body part in which the effect occurred. Alternatively, it is possible to display the impact, impulse, acceleration and/or pressure effect as a color fading of the corresponding region of the body part in the graphic display. In addition, the intensity of the effect can be indicated either by a color fading in said region, or by coloring said region with different colors. For example, it is conceivable to display the intensity of the effect using a blending of color from green through yellow to red, i.e., with a red coloring of the region of the body part indicating an intense effect and a green coloring indicating a mild effect.

In a further advantageous embodiment of the invention, it is possible to insert a live image, recorded via TV or video camera, of the athlete or of the part of the athlete's body that is to be monitored, on the display device, as a graphic display of the body part that is to be monitored, and to display the measured values for the impact, impulse, acceleration and/or pressure effect by fading or discoloration of the live image.

Advantageously, transmission from the covering device to the display device is implemented by means of wireless technologies, for example, digital short-range radio or infrared transmission. Particularly suited for this are transmission technologies which are already established in the field of computer technology and can therefore be cost-effectively implemented, for example, so-called Bluetooth short-range wireless technology.

In sports such as boxing, kickboxing, and other full-contact sports, for example, to permit a fully intended effect on the part of the athlete's body even when the covering element is being used, the covering element can be made of a soft, flexible material, in which the sensors and the associated controller with the transmission device are embedded. Leather is suitable as this material, for example. One side effect in this case is that the covering element also provides a certain protective effect. For example, for use in the sport of boxing, the covering element could be embodied as protective headgear, such as is customarily used in amateur boxing and during training, and can thus also perform a certain protective function, in addition to its function of detecting and transmitting the values of the effects. Because displaying the values of the effects provides a substantial added benefit to spectators, the display system can contribute to increasing the acceptance of protective clothing use in the widest range of sports.

For protecting the athlete, it is possible in a further embodiment of the invention for an alarm to be triggered when correspondingly predefined threshold values for the impact, impulse, acceleration and/or pressure effects are exceeded, which alarm will result in an examination by a doctor who is standing by, or in stopping the event if it is feared that the effect may present a danger to the health of the athlete. Optical signals can be used as the display on the display device. However, it is also possible for an acoustic signal to be emitted, alternatively or in addition to the optical display on the graphic display of the body part in the display device. Said acoustic signal can be emitted only when the alarm/threshold value is exceeded, or can be generally emitted in the event of an effect, wherein the pitch and/or tone can be modulated on the basis of the intensity of the effect.

One particularly preferred embodiment of the invention relates to the use of the display system during boxing events. In this case, protecting the head is of particular importance. Therefore, a hat/cap or thin helmet made of leather or some other soft material is used as the covering element. Said protective headgear has a defined thickness and contains a plurality of pressure sensors, which are integrated into the protective headgear, spaced at a defined distance from one another. The intensity and the striking location of hits to the head can thereby be detected and measured by the pressure sensors. With sensors arranged in a correspondingly close configuration, the size of the strike area can also be detected, because a plurality of sensors are actuated simultaneously by the hit.

The outputs of the sensors arranged in close configuration in the protective headgear are transmitted in a wireless manner by means of a transmission device, for example, by means of radio or infrared technology, to an external receiving device. An additional controller or control mechanism, which pre-processes the transmitted data, for example with respect to the assignment of the individual pressure sensors to a specific location in the protective headgear, can also be situated upstream.

The receiving device is connected to a display device, which can be implemented, for example, as a computer. The computer evaluates the received data and is used to further process and display the received pressure values. Large screens which can be suspended so as to be visible to spectators, for example, are particularly well suited for the display. The video projection screens that frequently are already present in large sports arenas can advantageously be used for this purpose. Alternatively, video projectors, so-called beamers, may also be used.

To make a display of a hit easily visible to spectators, the intensity and the location of the hit can be indicated using coloring or fading with different colors on a display of the head of the boxer. The graphic display which is used as the basis for the display of the hit can be a schematic illustration of the head. However, it is also possible to record the actual head of the boxer in the computer, from the frequently existing camera images, by means of motion detection, and to use this on the display device to illustrate the hit. For this purpose, in one advantageous embodiment of the invention, corresponding markings can be provided on the protective headgear, to facilitate motion detection in the computer and improve assignment of the hit to a location.

To protect the athlete against injuries, the pressure sensors are correspondingly calibrated, and a threshold for intervention of a ring doctor is established. In addition, a summation of hits to the head can also be used as the threshold for potentially stopping a fight when a predefined total of acceleration injuries to the head is reached.

To achieve the most complete detection of hits to the head, the protective headgear should also cover the chin region and parts of the neck, to allow the detection of hits that strike said areas.

1. A system for displaying impact, impulse, acceleration, and/or pressure effects on a part of the body of a living thing, the system comprising a covering element for covering the part of the body that is to be monitored, said element having sensors for detecting impact, impulse, acceleration and/or pressure effects, and a transmission device for transmitting the impact, impulse, acceleration and/or pressure values detected by the sensors, a receiving device for receiving the transmitted impact, impulse, acceleration and/or pressure values, and a display device for the transmitted impact, impulse, acceleration, and/or pressure values, the system further comprising: a plurality of sensors arranged within the covering element, at a spatial distance from each other, for detecting the location and the intensity of the impact, impulse, acceleration and/or pressure effects, and wherein information about the location of the impact, impulse, acceleration, and/or pressure effects and/or for identifying the detecting sensor is transmitted, together with the detected impact, impulse, acceleration, and/or pressure effects, by the transmission device.

2. The system according to claim 1, wherein the display device is embodied for displaying the location and intensity of the impact, impulse, acceleration and/or pressure effect.

3. The system according to claim 1, wherein the display device displays a graphic depiction of the part of the body to be monitored, wherein the impact, impulse, acceleration, and/or pressure effect on the part of the body is displayed in near-real time on the graphic depiction of the body part.

4. The system according to claim 3, wherein the impact, impulse, acceleration and/or pressure values are displayed using color fading or different coloring for the corresponding regions of the body part in the graphic depiction of the body part on the display device.

5. The system according to claim 3 wherein the graphic depiction of the body part is a camera recording of the body part played back in near-real time or in real time.

6. The system according to claim 5 wherein the transmission is wireless.

7. The system according to claim 3 wherein the part of the body to be monitored is the head, and the covering element is embodied as a protective headgear, wherein the covering element is made of a soft material and the sensors are embedded in the soft material.

8. The system according to claim 3 wherein when a predefined threshold value is exceeded an alarm is emitted.

9. The system according to claim 3 wherein, in addition to the display on the display device, an acoustic signal is generated when an impact, impulse, acceleration and/or pressure effect occurs.

10. The system according to claim 9, wherein the acoustic signal is modulated in terms of volume and/or the nature of the tone signal, on the basis of the intensity and/or the location of the impact, impulse, acceleration and/or pressure effect.

11. A covering element for a system for displaying impact, impulse, acceleration and/or pressure effects on a part of the body, according to claim 10 wherein a plurality of sensors for detecting impact, impulse, acceleration and/or pressure effects are arranged in the covering element, spatially separated from one another.

12. A display device for a system for displaying impact, impulse, acceleration and/or pressure effects on a part of the body, according to claim 11 wherein the display comprises a graphic depiction of the body part, wherein the impact, impulse, acceleration and/or pressure effects are displayed on the corresponding region of the body part, particularly using color fading and/or different colors.
